(19) United States
(12) Patent Application Publication
(10) Pub. No.: US 2014/0345738 A1
(43) Pub. Date: Nov. 27, 2014

(54) HOSE BURST SUPPRESSION SLEEVE SYSTEM

(71) Applicant: THE GATES CORPORATION, Denver, CO (US)

(72) Inventors: Jay Rick Hill, Parker, CO (US); Jonathan James McKinley, Corpus Christi, TX (US); Yelena Gray, Parker, CO (US); Andy Hills, Eynesbury (GB); Kim Henderson, Castle Pines, CO (US); Jonathan Clark Swift, Cambridge (GB)

(21) Appl. No.: 14/452,384

(22) Filed: Aug. 5, 2014

Related U.S. Application Data
(63) Continuation-in-part of application No. PCT/US2013/072266, filed on Nov. 27, 2013.
(60) Provisional application No. 61/740,734, filed on Dec. 21, 2012.

(51) Int. Cl. F16L 11/10

(52) U.S. Cl. CPC F16L 11/10
USPC 138/118.1; 29/428

(57) ABSTRACT

A protective suppression system including one or more sleeves of expansion coil of energy-absorbing material wrapped around a hose and a blanket which can be wrapped loosely around the wrapped hose. The longitudinal edges of the blanket fasten together to form a protective cylindrical tube, and can be joined end-to-end with one or more additional blankets to extend the protective tube to a desired total length. The system thus can provide improved safety to personnel and the environment by shielding a hose under pressure to suppress bursts, block leaks and by redirecting or channeling test fluids and cleaning fluids.

### CROSS REFERENCE TO RELATED APPLICATIONS

This application is a continuation-in-part of international application number PCT/US2013/072266 filed Nov. 27, 2013, which claims priority from U.S. Provisional Application No. 61/740,734 filed Dec. 21, 2012, the entire contents of each of which are hereby incorporated herein by reference.

### BACKGROUND OF THE INVENTION

1. Field of the Invention

This invention relates generally to a protective blanket system used to shield and suppress fluid leaks from a hose under high internal pressure, more particularly to a system with a blanket that can be coiled loosely around a helically-wrapped hose and secured in a tubular shape and wherein multiple blankets can be joined end-to-end.

2. Description of the Prior Art

In recent years, improved safety practices in the oil and gas industry have required oil rig operators to recertify critical equipment. There are now industry guidelines from organizations like ‘Oil and Gas UK’ which companies need to follow in order to demonstrate industry best practice. One part of these best practices relates to the recertification or revalidation of critical hoses. Current practice involves pressurizing the hose to be recertified to a specified pressure and duration determined by the manufacturer's guidelines. The hoses are held at pressure for a specified amount of time, which can be as short as under 15 minutes or as long as 24 hours or more. The hoses are monitored continuously while they are pressurized. Hoses are failed or taken out of service if they are not able to hold pressure for the amount of time specified by the manufacturer.

Current practices include laying pressurized hose on the ground for extended periods of time, which may expose personnel to unsafe conditions. Hose bursts and/or leaks may be dangerous to personnel or equipment. The hoses are also washed. The test fluids and/or wash fluids may be environmentally hazardous.

What is needed is hose test apparatus and methods with improved safety to personnel and the environment.

### SUMMARY

The present invention is directed to systems and methods which provide improved safety to personnel and the environment by shielding a hose or a hose assembly under pressure to suppress or control ruptures, block leaks and redirect fluid leaks, test fluids and cleaning fluids. The present invention is directed to a suppression system including an expansion coil and a protective blanket. The hose may advantageously be helically wrapped with the expansion coil, which may be a strip of energy-absorbing material that is applied before the blanket is applied. The energy-absorbing material may be a thermoplastic strip, such as polyurethane. Multiple helically wrapped layers of the expansion coil may be applied to the hose. The protective blanket can be wrapped loosely around a helically wrapped hose, fastening the longitudinal edges together to form a protective cylindrical tube, and/or joined end-to-end with one or more additional blankets to extend the protective tube to a desired total length. The system can suppress the burst of a failed hose up to two-times the working pressure of the hose. The suppression sleeve system can be applied to an existing hose assembly either at the time the hose assembly is made or later in the field.

The blankets may include a longitudinal edge fastening system and an end-to-end, end fastening system. The edges and/or ends of the blanket may be reinforced and/or raised or thicker relative to the body of the blanket. Joining the edges to form the tube and joining the ends to form a longer tube are both preferably done with some overlap. The blanket may be reinforced throughout or at least in the main body portion with one or more fabric or sheet-type reinforcement materials. One end of each blanket may include a pocket, with the other end adapted to fit within the pocket.

The invention is also directed to a method of pressure testing a hose including wrapping a length of blanket material around the hose; overlapping the longitudinal edges; fastening the wrapped blanket securely; and pressurizing the hose. The wrapped blanket may have an inside diameter about or at least twice the hose outside diameter. The method may include joining two or more of said blankets end-to-end. The method may include wrapping two or more lengths of blanket material which are joined end-to-end around the hose.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The accompanying drawings, which are incorporated in and form part of the specification in which like numerals designate like parts, illustrate embodiments of the present invention and together with the description, serve to explain the principles of the invention. In the drawings:

FIG. 1 is a perspective view of an embodiment of the blanket coiled up;

FIG. 2 is a perspective view of an embodiment of the blanket laid flat;

FIG. 3 is a partially fragmented sectional view of an embodiment of the blanket;

FIG. 4 is a top view of another embodiment of the blanket;

FIG. 5 is a partially fragmented view of an embodiment of the blanket;

FIG. 6 is a perspective view of an embodiment of the blanket in use;

FIG. 7 is a perspective view of an embodiment of the blanket in another use;

FIG. 8 is a partially fragmented perspective view showing another embodiment of the blanket;

FIG. 9 is a perspective view of an expansion coil according to the invention; and

FIG. 10 illustrates a hose assembly and the extent of application thereon of the inventive system.

### DETAILED DESCRIPTION

The present invention provides a protective blanket useful for proof testing of the high-pressure, long-length, large-diameter hoses in the field environment for the purpose of recertification or revalidation of the hose assembly. Currently, hoses used on oil rigs or similar applications are proof tested and revalidated before being put back into service. If there is no enclosure to protect the operator or equipment in the vicinity performing this task, then if hose failure occurs during proof testing, the operators could be in danger of exposure to high pressure test fluid or debris released.

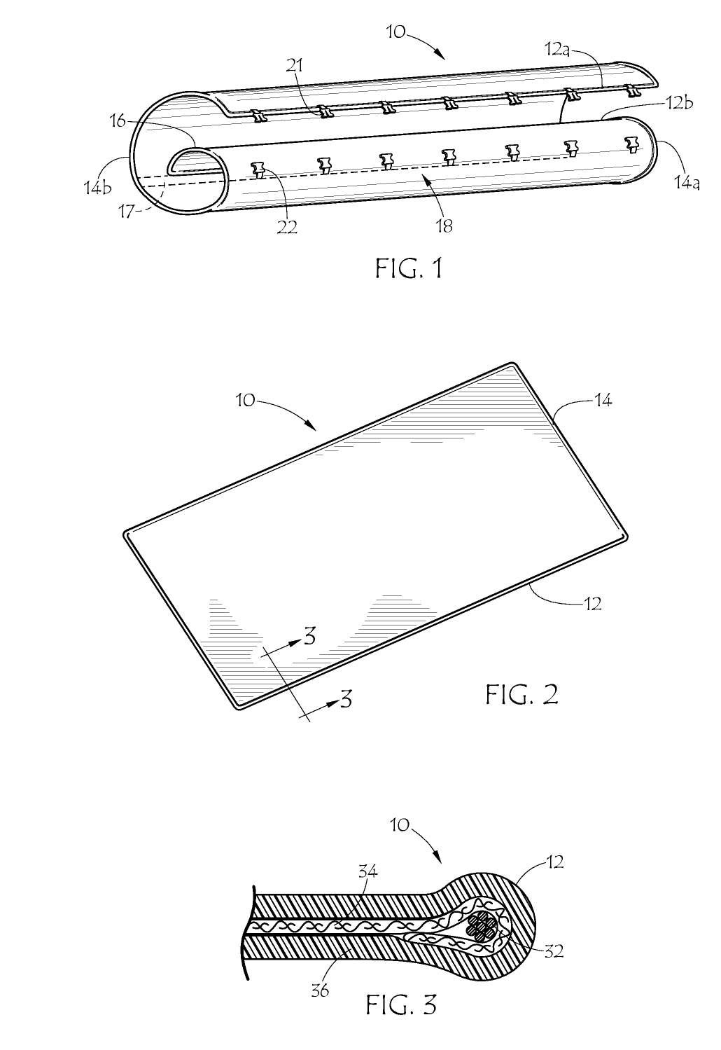

FIG. 1 shows a first embodiment of the inventive fluid suppression blanket. In FIG. 1, fluid suppression blanket 10 is in the form of a rectangular sheet partially coiled in the longitudinal direction. Blanket 10 has two longitudinal edges 12a and 12b, and two end edges, or ends 14a and 14b. Blanket 10 is adapted to coil around a hose or other tubular object in a tubular or cylindrical form, and is adapted so one edge 12a overlaps the other edge 12b, defining an overlap portion 16 of overlap distance 17. Blanket 10 includes longitudinal edge fastener system 18. The edge fastener system may be comprised of buckles, hooks, loops and eyes, ties, chains and locks or other fastening mechanisms or systems. Edge fastener system 18 as shown comprises a number of buckles with male buckle portions 21 and female buckle portions 22. FIG. 2 shows containment blanket 10 in a flat configuration. At least one edge of ends 14 and edges 12 may be reinforced. All peripheral edges 14 and 12 of the blanket may be reinforced.

FIG. 3 shows a partially fragmented section including an edge 12 of suppression blanket 10. The edge is reinforced with a cord 32, which may be any type of suitable reinforcing material or construction such as a multi- or mono-filament strand, yarn, wire, rope or cable made of metal wire, carbon or glass or other inorganic fiber, natural or synthetic organic fibers or filaments, or composites or hybrids thereof. Blanket 10 has a body 36 which is formed of an impervious polymeric (either plastic or elastomeric, and either thermoplastic or thermoset) material and includes sheet-like reinforcement 34. The body 34 may, for example, be of PVC (polyvinylchloride), polyurethane, polyolefin, rubber, or the like. The reinforcement could be any suitable textile reinforcement such as a woven fabric, nonwoven fabric, knit fabric or the like. In one embodiment the fabric is square woven and may include polyamide and/or aramid fibers. Aramid fibers include for example, para-aramid fibers, meta-aramid fibers and aramid copolymer fibers. The reinforcement may result in edge 12 being thicker than body 36. One or more edges may include reinforcement 32. Preferably the two longitudinal edges are reinforced and thicker than the body.

The body material may penetrate the reinforcing fabric. The thickness of the blanket body may be substantially thicker than the reinforcing fabric as indicated in FIG. 3, or about the thickness of the reinforcing fabric, or anywhere in between. The reinforcement in the blanket may include just one layer or may be multiple layers of similar or different materials depending on the performance needs of the application. The blanket may include just one or multiple layers of fabric, wire strand or mesh reinforcement, including layers of different materials. The fabric may be treated with an adhesive composition if needed for improved bonding to the body material. The textile reinforcement material could be a high-performance polymeric material such as of para-aramid, ultra-high molecular weight polyethylene (UHMWPE), a liquid crystalline polymer (LCP), Nylon, Polyester, or the like, or blends thereof. More, stronger reinforcement would be used for blankets to be used for testing very high pressure hoses in order to contain the energy should the hose burst. Thus, the blanket size, thickness, strength, and the like can be selected to suit a particular hose-test or protective application.

As an example of a particular embodiment, consider a blanket suitable for fluid suppression when testing critical hoses used in off-shore oil-drilling operations. These hoses may be nominally three to six inches in inside diameter and up to 200 feet long or more. Hose assemblies tested using with blanket are typically composed of 2 couplings and a free length of hose. The blankets do not need to be quite as long as the whole hose assembly provided they are longer than the length of free hose. The blankets may be of differing lengths and widths depending upon what is practical for each situation. The blanket width is sized to wrap loosely around a hose or pipe. A single blanket could be used on a short hose (under 10 feet), and could, for example, be approximately 8-foot by 4-foot, and it could have multiple layers of high performance textile. The blanket could thus wrap around the hose, coiling up in the 4-foot direction, covering an 8-foot length of hose. Blanket longitudinal edges may be secured around the hose with buckles, zipper, hooks, hook-and-loop fasteners, etc. to prevent uncoiling in case of a hose failure. Significant overlap in the longitudinal edges is desirable in order to create a reasonably liquid tight cover for fluid containment. According to one embodiment, the loosely wrapped blanket may have an inside diameter that is about, or at least, twice the hose outside diameter. Such a proportion is advantageous for suppressing, containing or redirecting a high-volume surge of fluid from a total rupture of the hose. Preferably the buckles are on straps that completely encircle the coiled blanket tube for additional reinforcement of the blanket. The straps may be stitched or otherwise fastened permanently to the blanket. The buckle position and strap fastening to the blanket may be adapted to require a suitable degree of overlap of the edges when the blanket is coiled. Likewise, the buckle position and strap fastening to the blanket may be adapted to prevent too much overlap and thereby prevent too tight a fit about a hose when the blanket is coiled. If the blanket were to tightly enclose the hose, there would be insufficient space to accommodate a significant volume of fluid. Thus, the embodiment of FIG. 1 shows female buckle portions 22 located a distance 17 from an edge, thus forcing an overlap distance 17 when fastened to male buckle portions 21. This buckle arrangement prevents the blanket from being fastened if the hose is too large to permit the required overlap. A significant overlap distance 17 may be on the order of the diameter of the hose the blanket is adapted for, or about half the inside diameter of the coiled blanket tube. If the overlap is only minimal, slight or not present, then a high pressure leak could easily escape the blanket and endanger a person nearby.

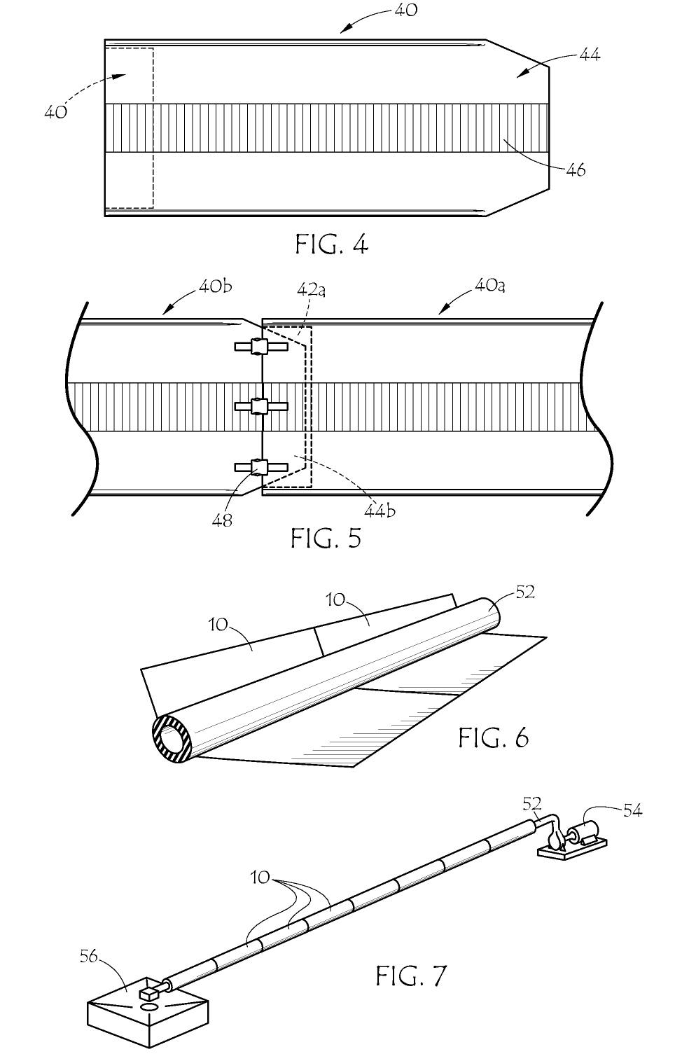

Multiple such blankets may be joined together end-to-end in order to cover hoses longer than one blanket (i.e. longer than 8 feet in this example.) FIGS. 4 and 5 illustrate one possible end-to-end fastening system. In FIG. 4, blanket 40 has pocket 42 formed on one end and insert portion 44 in the form of a tapered tab on the other end. Thus, as illustrated in FIG. 5, tab 44b of second blanket 40b may be inserted into pocket 42a of first blanket 40a. In addition, FIG. 5 shows the end fastening system includes three buckles 48 to secure the blankets together end-to-end. Multiple blankets could be attached together this way, for example, enough to cover a 200-foot hose or more. Other end fastening systems could be used besides pocket and buckles, such as overlaps or pockets with buckles, zippers, hooks, hook-and-loop closure, or the like. Overlaps are desirable in order to create a reasonably liquid tight length of multiple suppression blankets. Then any liquid resulting from a leak or burst of the test hose can be directed to one end or the other for safe collection and/or disposal. In this example, an overlap of ½ foot or one foot up to two feet may be desirable to prevent spill-overs. This example blanket is expected to be able to suppress the fluid from hose bursts or leaks at pressures up to 30,000 psi or up to two times the rated working pressure of the hose. The temperature of the test fluid as well as the area surrounding the test hose could reach as high as 175° F., or up to 180° F., 212° F., or 250° F., or whatever temperature is specified in a test protocol, and suitable materials with this thermal resistance are available.

It may also be noted that blanket 40 in FIG. 4 is shown with only the two longer edges reinforced with a cord and/or made thicker than the blanket body. This and other variations or options are considered within the scope of the invention. The embodiment(s) discussed above have a cohesive blanket body which may be considered a single, cohesive structure although possibly a built up laminate. If there are multiple layers in the laminate, they are firmly attached together and bonded, preferably all penetrated with body material or adhesive or both. The embodiment(s) presented next includes loose, unattached, intermediate layers within the blanket.

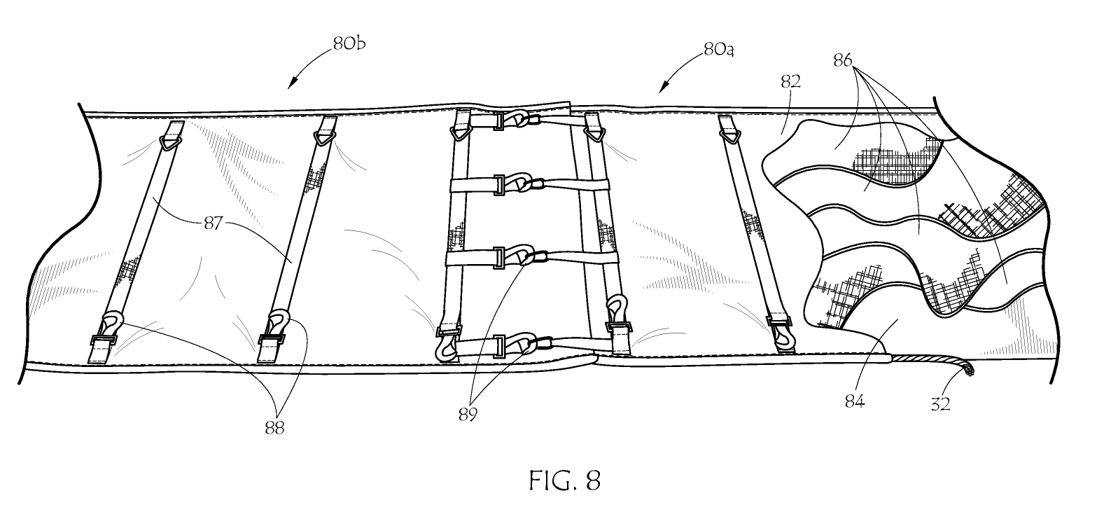

FIG. 8 illustrates a second embodiment of the inventive blankets 80a and 80b, showing a partially fragmented cross section of blanket 80a having multiple, loose layers of sheet materials, including impervious outer and inner cover layers and internal reinforcing fabric layers. In FIG. 8, there are two impervious layers, outer cover layer 82 and inner cover layer 84, along with a number of pervious layers of fabric 86 sandwiched in between. Buckles 88 are attached to reinforcing webbings 87 which then encircle the coiled blanket completely, increasing the hoop strength of the blanket. Similar buckles 89 are used to join blankets end-to-end. Pervious layers 86 may help to contain fluid that happens to penetrate an impervious layer. Edge-cord reinforcement 32 is present on the two long edges of each blanket. Webbings 87 are fastened to outer layer 82 only. In other words, the webbings are not stitched in a way that anchors the fabric layers 86 to the outer layer 82 or to the inner layer 84. The internal fabric layers 86 are thus not anchored to the cover layers except at the edges, i.e. around the periphery, of the blanket, where all the layers are joined together. The blankets 80 may also have a pocket for end-to-end joining as illustrated in FIGS. 4 and 5.

In the embodiment of FIG. 8, inner and outer layers 82 and 84 may be constructed in the manner described above for the first embodiment, namely of impervious material and fabric reinforcement. On the other hand, the internal fabric layers 86 are preferably of a high-elongation, pervious, fibrous material such as low to medium tenacity nylon. The internal fabric layers 86 are preferably of a fiber material having more than 5% tensile elongation, or at least 6% elongation, or an elongation at break of 10% or more or 15% or more. Examples of such high-elongation fibers include medium-tenacity polyester, and medium- or high-tenacity nylon. A preferred fiber is medium-tenacity nylon. The fabric layers 86 are preferably not high-modulus, low-elongation fibers such as aramid fibers. The fabric layers 86 are preferably not of brittle or friable fiber materials such as glass. The fabric layers 86 may be woven, non-woven, or knit fabric. The fabric layers 86 may be woven of medium-tenacity nylon 6-6 fibers, and these fibers may be continuous filaments with no texturizing of the fibers. The high-elongation fibers may be characterized by elongation at break in the range of 10% to 30% or from 15% to 25%.

Blankets made according to either embodiment of the invention, offer a relatively light weight protective solution that also provides flexibility and maneuverability during a hose test procedure or during installation of the blanket(s). Multiple blankets could be attached together to accommodate any reasonable length of hose. The blankets may also be provided with a lengthwise hose placement indicator, which is shown in the form of a colored stripe 46 in FIG. 4. Stripe 46 is indicated as red in FIG. 4, but any suitable color or pattern may be used. The placement indicator facilitates alignment and use of the blanket or of the hose with the blanket.

FIGS. 6 and 7 illustrate two uses of the inventive blankets.

FIG. 6 illustrates a first use of the inventive blankets laid open under a hose, for example for hose cleaning The edge reinforcement of either embodiment of the invention may result in the reinforced, peripheral edges of the blanket being thicker or raised relative to the body of a blanket when a blanket is laid flat. As a result of the raised edge, the blanket will hold a limited amount of water or test fluid when laid flat. The raised edge thus allows for the hose to be cleaned or washed while collecting or containing the runoff of wash fluid, thus preventing contamination of the immediate vicinity. Doing this on a slope will result in the wash fluid being channeled to one end of the blanket, or to the end of a series of blankets where the fluid can be safely collected. In FIG. 6, two blankets 10 are joined end-to-end and laid under test hose 52. The natural curvature of the blankets as well as the raised edges help to channel wash fluids or other runoff downhill toward an end of the blankets. Any number of blankets in the open, flat position can be joined end-to-end as needed for cleaning a hose or pipe of given length.

FIG. 7 illustrates a hose test system incorporating a number of blankets 10 which are joined end-to-end and coiled and fastened loosely around a long length of hose 52. Hose 52 is filled and pressurized by high-pressure pump 54 at one end and capped at the other end. The other end may also be arranged to be lower than the first end so that spent test fluid may be drained to the collection reservoir 56 located at that end. Likewise, any fluid collecting inside the blankets from leaks, bursts or the like can be drained to the end of the line into collection reservoir 56. Either embodiment of the invention may be utilized in such a test system. Any number of blankets in the coiled, tubular position can be joined end-to-end as needed for shielding, suppressing, or redirecting leaks or bursts from a test hose or pipe of given length.

Co-pending provisional application with Ser. No. 61/709,983 filed Oct. 4, 2012, with first inventor Kim Henderson, assigned to The Gates Corporation, and titled “Transportable Hose-Test Containers, Systems and Methods” is hereby incorporated herein by reference in its entirety. The transportable test system described in that application may include a fluid containment subsystem which may include fluid collection apparatus, reservoir, etc. The collection apparatus may include hose test stands, blanket (flexible channel), drain, etc. Stands may be of varying and/or adjustable height and/or shape to facilitate flow of fluid runoff toward the fluid collection apparatus and collection reservoir located in one of the IMR test modules described therein. An embodiment of the present invention may suitably be used as the blanket(s) for the fluid containment subsystem of that provisional patent application. The blanket(s) when laid flat or slightly curved concave upwards to form an open channel under the hose being tested, and possibly in conjunction with the hose stands, may collect wash water and then facilitate draining of the external wash water back to one of the reservoirs contained in the test modules. The blanket(s) in a wrapped configuration may also contain leaks or surges of fluid during the hose testing and again facilitate draining of the leaked test fluid or water back to one of the reservoirs contained in the test modules.

According to an embodiment of the invention, there is described now a method of pressure testing a hose including loosely wrapping a length of blanket material around the hose; overlapping the longitudinal edges; fastening the wrapped blanket securely; and pressurizing the hose. The wrapped blanket may have an inside diameter about or at least twice the hose outside diameter. The method may include joining two or more of said blankets end-to-end. The method may include wrapping two or more lengths of blanket material which are joined end-to-end around the hose. These and other aspects of the method are illustrated in FIG's 6 and 7 and described in provisional application 61/709,983.

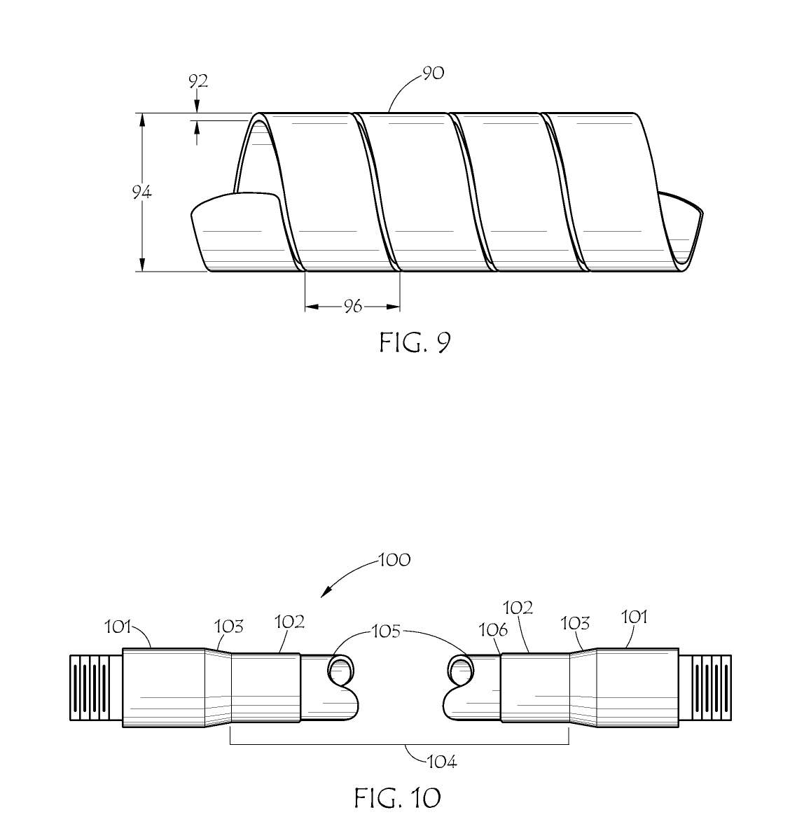

FIG. 9 illustrates expansion coil 90 which may be installed as a helically wrapped sleeve around a length of hose before coiling the blanket around the hose. Expansion coil 90 may have a predetermined thickness 92, overall diameter 94, and width or helical pitch 96. Two or more layers of expansion coil 90 may be wrapped around the hose before coiling the blanket around the hose. For example, the tube 52 in FIG. 6 may represent a hose length wrapped with one or more layers of expansion coil (not shown) with blankets 10 ready to then be wrapped around the assembly. The sleeve diameter 94 may be adjusted by twisting the expansion coil. The wrapping of the coil may be somewhat loose and need not be completely tight. If multiple sleeve layers are used, the helix direction may be the same for all layers or different for some layers. A particularly good coverage effect may be achieved with two layers with opposite helix directions.

The material of the expansion coil is an energy-absorbing material so that the energy from a catastrophic rupture of the hose may be absorbed by the material. The energy-absorbing material may be a thermoplastic or thermoset polymeric material. For convenient shaping or fitting of the material, a thermoplastic coil has advantages. The material may be a thermoplastic or thermoset elastomeric material, preferably with good damping or shock-absorbing properties. Thermoplastic polyurethane materials have proven useful for their high strength and energy-absorbing properties and ease of handling and reshaping. The material generally should be non-metallic and should not be a rigid material such as a metal or a high modulus thermoplastic.

FIG. 10 illustrates how to ensure the coil or sleeve is the proper length 104 for the application. The coil is best placed on the hose assembly 100 up to each swage bubble 103 of each fitting 101. The sleeve should at least extend past the inboard end 106 of each fitting 101, preferably up to the bubble 103 of the swage 102 for a swaged fitting 101 as indicated in FIG. 10. The following installation procedure was applied in an example, but the procedure can be adapted to any hose diameter or length.

An example hose suppression sleeve system was applied on a 3½″ Grade D vibrator hose assembly comprising a length of hose with a metal fitting swaged onto each end. First a helical coil of polyurethane material was applied to the length of the hose. The expansion coil diameter was 140 mm (5.5″), the strip width was 50 mm (2″), and the strip thickness was 4.74 mm ( 3/16″). A first layer of the expansion coil was spiraled onto the hose assembly. The expansion coil was measured and cut to extend past the inboard end of each fitting. The hose was about 133 mm (5.25 inch) in diameter. The expansion coil was wrapped around the body of the hose to extend past the inboard end of the fitting, but not past the swage. The expansion coil was not tightly wrapped against the body of the hose. The coil can be loosened by twisting the ends towards each other, if it is too tight on the hose. The expansion coil is advantageously fit loosely around the hose.

A second expansion coil layer was then applied onto the first sleeve layer on the hose. The second sleeve layer may be preformed prior to installation on the hose assembly. The second expansion coil in this example was the same size and material as the first layer, so it therefore required an additional 38% in length. The second piece of cut-to-length expansion coil was placed on a rotatable mandrel with a diameter of about 159 mm (6.25 inches). The expansion coil was then heated to reshape and resize it to the larger required diameter. In this example, the heating was done with a small propane torch. The mandrel was rotated as a gloss appeared on the coil so as to apply the heat as evenly as possible. The thermoplastic nature of a thermoplastic expansion coil material allows the coil to resize to a new diameter when heated by any suitable means. Once the plastic coil was evenly heated, a few minutes were allowed for the metal mandrel and the thermoplastic coil to cool. The expansion coil may be easily removed from the mandrel by twisting the ends towards each other. Upon twisting, the diameter will increase and the coil will slide off of the mandrel.

The second layer of resized expansion coil was then spiraled onto the hose assembly over the first expansion coil, both spiraled in the same direction in this example. Once the second sleeve was applied, the ends were twisted towards each other to close the gaps between the windings of coil and to ensure the coil fits as loosely as possible around the hose assembly.

Finally, the hose was ready for the blanket to be applied. The blanket may be applied on the ground by rolling the hose up in the suppression blanket or by placing the hose on a set of jack stands and wrapping the blanket around the hose assembly. Preferably, the blanket should not be wrapped on the hose tightly. Wrapping too tightly does not give the expansion coil room to expand sufficiently around the burst zone. The blanket should not be too loose either. The blanket should go around the hose at least two full times with about a 200-mm (8-inch) overlap. The blanket may then be secured on the hose by attaching the longitudinal fasteners. If more than one blanket is used for a longer hose length, then the end fastening system may then be engaged to secure the blankets together end-to-end.

These installation principles can be applied to crimped fittings or other fitting styles. The invention lends itself to any size of hose. The inventive burst suppression system may be applied to all kinds of high-pressure hoses such as rotary drilling, vibrator, cementing, sour service, choke & kill, motion compensator, de-coker, and blow-out preventer (“BOP”) oil field hoses, and the like.

Although the present invention and its advantages have been described in detail, it should be understood that various changes, substitutions, and alterations can be made herein without departing from the scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps. The invention disclosed herein may suitably be practiced in the absence of any element that is not specifically disclosed herein.

What is claimed is:

1. A burst suppression system comprising a first expansion coil and a blanket;
said expansion coil comprising a helical strip comprising an energy-absorbing material adapted in dimensions to helically sheath a length of hose to be contained; and said blanket comprising:
an impervious flexible sheet of fabric-reinforced material adapted to coil into a cylindrical tube around said wrapped length of hose and having two opposing cord-reinforced longitudinal edges; and a longitudinal fastener system adapted to retain the coiled shape of said cylindrical tube.

2. The burst suppression system of claim 1 wherein said helical strip comprises a thermoplastic material.

3. The burst suppression system of claim 1 wherein said helical strip comprises polyurethane.

4. The burst suppression system of claim 1 further comprising a second expansion coil applied over said first expansion coil.

5. The burst suppression system of claim 4 wherein said longitudinal edges of the coiled blanket overlap significantly when fastened.

6. The burst suppression system of claim 5 further comprising an end fastener system adapted so that two or more of the blankets can be joined together end-to-end to make a longer blanket.

7. A hose burst suppression system comprising a length of hose with a fitting on each end, an expansion coil helically wrapped around the length of hose between said fittings, and a blanket adapted to coil into a cylindrical tube around said helically wrapped hose.

8. The system of claim 7 wherein said blanket extends past each end of said coil and partially over said fittings.

9. The system of claim 7 further comprising a second expansion coil helically wrapped around the first expansion coil.

10. A method of protecting a hose assembly comprising:
helically wrapping a first length of expansion coil around a length of hose assembly comprising a hose and a fitting on each end of said hose, said coil extending from one said fitting to the other; and
wrapping a blanket loosely around the helically wrapped hose;
overlapping the longitudinal edges of said blanket; and
fastening the wrapped blanket securely.

11. The method of claim 10 further comprising helically wrapping a second length of expansion coil around said first length of expansion coil.
